(19) United States
(12) Patent Application Publication
(10) Pub. No.: US 2008/0128361 A1
(43) Pub. Date: Jun. 5, 2008

(54) Reduction of Sulfate Ions in Alcohols

(75) Inventors: Corey L. Zmolek, Bloomfield, IA (US); Jacqueline M. Fee, Elkhorn, NE (US); James T. Walsh, Dayton, OH (US)

Correspondence Address: FISH & RICHARDSON P.C., PO BOX 1022, MINNEAPOLIS, MN, 55440-1022, US

(73) Assignee: CARGILL, INCORPORATED, Wayzata, MN (US)

(21) Appl. No.: 11/565,372

(22) Filed: Nov. 30, 2006

(51) Int. Cl. B01J 41/14

(52) U.S. Cl. 210/683

(57) ABSTRACT

A method is described for reducing sulfate ions in a first alcohol, including contacting a first alcohol comprising sulfate ions with an anion resin to reduce the concentration of sulfate ions present in the first alcohol and form a treated alcohol.

### TECHNICAL FIELD

The invention relates to reducing sulfates in alcohols.

### BACKGROUND

There is increasing interest in the use of alternative fuels as motor fuels and motor fuel components, such as gasoline blend components. The overall composition and content of a motor fuel is affected by the composition and content of each motor fuel component. The composition and content of motor fuels, including gasoline, are generally subject to EPA and other governmental regulations and standards.

One alternative fuel attracting increasing interest is ethanol. Ethanol is a renewable energy source that is being increasingly used in motor fuels. This use has led to an increase in pollution concerns. Based on these concerns, a new industry-wide standard specification has been proposed for ethanol designated for blending with gasoline. The new proposed standard includes a 10 ppm maximum sulfur limit and a 4 ppm maximum sulfate limit for ethanol. As ethanol is often produced with a sulfate content greater than 4 ppm, generally the amount of sulfates must be reduced for ethanol to meet the new standard.

Sulfate reduction has been accomplished using various methods. One method for reducing sulfate in effluent streams uses microbial and/or bacterial action. The microbes and bacteria used often subsist on organic components, such as ethanol, present in the effluent streams. Therefore, a microbial/bacterial approach may not be optimal for use with a primarily organic stream, such as an ethanol product. One non-biological method of reducing sulfates in an organic stream, such as an alcohol, is to contact the stream with copper. Another non-biological method uses flash tanks to volatize various sulfur species out of an organic stream. However, these non-biological methods can be quite expensive when used to treat large volumes of material. The costs are driven in part by the need to replace the copper which is used up by contact and reaction with sulfur species, or by the capital costs of large flash tanks and/or expense of generating strong vacuum used to remove the amounts of sulfur species from the flash tanks.

### SUMMARY

An anion resin may be used to remove sulfur-containing ions from an alcohol stream.

In one aspect, a method for reducing sulfate ions in a first alcohol is described, including contacting a first alcohol comprising sulfate ions with an anion resin to reduce the concentration of sulfate ions present in the first alcohol and form a treated alcohol.

The first alcohol may include C1 to C7 alcohols. The first alcohol may include ethanol. The first alcohol may have a sulfate ion concentration of 4 ppm or greater. The first alcohol may be derived from biomass. The first alcohol further may include additional sulfur-containing ions and contacting the first alcohol with an anion resin may reduce the concentration of additional sulfur-containing ions. The anion resin may include a hydroxide based resin.

The treated alcohol may have a total sulfur concentration of 10 ppm or less. Variously, the treated alcohol may have a sulfate ion concentration of 4 ppm or less, 2 ppm or less, or 1 ppm or less. Variously, the treated alcohol may be produced at a rate of 1 gallon per minute or more, or at a rate of 50 gallons per minute or more.

In another aspect, a method for reducing sulfate ions in ethanol is described, including contacting an ethanol comprising sulfate ions with an anion resin to reduce the concentration of sulfate ions present in the ethanol and form a treated ethanol having a sulfate ion concentration of 4 ppm or less.

The ethanol may have a sulfate ion concentration of 4 ppm or greater. The ethanol may further include additional sulfur-containing ions and contacting the ethanol with an anion resin may reduce the concentration of additional sulfur-containing ions. The anion resin may include a hydroxide based resin.

Variously, the treated ethanol may have a sulfate ion concentration of 2 ppm or less, or a sulfate ion concentration of 1 ppm or less. The treated ethanol may have a total sulfur concentration of 10 ppm or less. Variously, the treated ethanol may be produced at a rate of 1 gallon per minute or more, or at a rate of 50 gallons per minute or more.

In another aspect, a method of producing a motor fuel component is described, including contacting an ethanol with an anion resin to reduce the concentration of sulfate ions in the ethanol and form a treated ethanol, and adding a denaturant to the treated ethanol. The treated ethanol may have a sulfate ion concentration of 4 ppm or less. The denaturant may include natural gasoline, unleaded gasoline, reformate, or naphtha components. The denaturant may include denatonium benzoate.

The details of one or more embodiments of the invention are set forth in the description below. Other features, objects, and advantages of the invention will be apparent from the description and from the claims.

### DETAILED DESCRIPTION

A process and system are described for removing sulfate anions from alcohol. Sulfate ions present in the alcohol may be removed by contact with an anion resin. The resulting treated alcohol has reduced sulfate ion content compared to the alcohol. The alcohol to be treated may be referred to as a feedstock alcohol or as a first alcohol. The alcohol may be hydrous or anhydrous, and may be relatively pure, or may have other components added to the alcohol. The alcohol may be provided by a refinery that produces an alcohol stream for treatment.

Various alcohols may be treated by the process. In one embodiment, short chain alcohols, having from 1 to 7 carbon atoms, may be treated. In one embodiment, the alcohol to be treated includes ethanol. In addition, feedstock having a range of alcohol concentrations may be treated. Variously, the alcohol concentration may be 1% or more, although treatment is generally more efficient at higher concentration levels. For example, an alcohol to be treated may have a proof of 100 or greater may be 150 proof or greater, or may be 170 proof or greater. In one embodiment, an alcohol to be treated may be from about 180 to about 200 proof.

The alcohol to be treated includes sulfate ions. The sulfate ion content in the feedstock alcohol may range from parts per billion (ppb) up to several hundred parts per million (ppm). In various embodiments, the sulfate ion concentration in the feedstock alcohol may range from 1 ppm to 100 ppm, from 2 ppm to 20 ppm, or from 4 ppm to 10 ppm. In some embodiments, the alcohol may also include additional sulfur-containing ions. For example, the feedstock alcohol may also include sulfite ions.

Processing the alcohol reduces the sulfate ion concentration in the alcohol. The amount of reduction may vary depending on several factors. These factors may include the processing conditions used, the age and loading of the resin, the sulfate ion concentration in the feedstock alcohol, as well as other factors. In some embodiments, the concentration of sulfate ions in the treated alcohol may be used to indicate when the anion resin should be changed or the treatment conditions modified. In various embodiments, the feedstock alcohol may be treated to produce a treated alcohol having a sulfate ion concentration of 4 ppm or less, 2 ppm or less, or 1 ppm or less. In some embodiments, processing the feedstock alcohol may also reduce the concentration of additional sulfur-containing ions.

Various anion resins may be used to treat the feedstock alcohol. Both weak and strong anion resins may be used. Examples of anion resins that may be used include OH⁻ based resins and Cl⁻ based resins, although other anion based resins may also be used. Different resins may have similar performance capabilities in the reduction of sulfate ions. However, there may be specifications or other considerations that may affect the choice of resins to be used. These specifications or other considerations may include specifications on the treated alcohol, specifications on the product in which the treated alcohol will be used, the type of anions being removed, and the type and concentration of the alcohol being treated. For example, an ethanol product typically includes a chloride ion specification. In some embodiments, therefore, anion resins such as an OH⁻ based resin may be preferred over a Cl⁻ based resin for processing ethanol. In some embodiments, strong basic anion resins may be preferred. In some embodiments, the performance of the anion resin in removing additional sulfur-containing ions will also be a consideration. Examples of anion resins that may be used include Lewatit® M+M-600 series resins and Lewatit® M+M-500 series resins (available from Bayer), DOWEX® MARA-OH and DOWEX® IX-22-OH resins (available from Dow Chemical), and Purolite® A-100 and A-300 resins (available from Purolite).

A variety of processes may be used to contact the with the anion resin. Various approaches may be used to pass the alcohol over and/or through the anion resin. In one embodiment, the alcohol may contact the anion resin by passing an alcohol stream through one or more resin beds including the anion resin. In other embodiments, the alcohol may contact the anion resin through the use of one or more resin cartridges, leaf filters, or by using other approaches or equipment.

Following treatment, additional components may be added to the treated alcohol. In one embodiment, a denaturant is added to the treated alcohol. Examples of denaturants that maybe used include natural gasoline, unleaded gasoline, reformate, naphtha components, or denatonium benzoate (such as Bitrex, available from Bitrex, Portland, Oreg.).

Following processing, the anion resin may be regenerated. Depending on processing conditions and other factors, the resin may be regenerated on a schedule. For example, the resin may be regenerated periodically, or the resin may be regenerated as determined necessary by output stream testing. Other approaches for regeneration may also be taken. The regeneration process may include passing an anion-containing stream over the anion resin. Examples of anion-containing streams that may be used for regeneration include NaOH, NaCl, etc. In one embodiment, during regeneration the anion stream will dislodge sulfur species from the resin and replace the sulfur anions with the anion in the regeneration stream, such as OH⁻. For example, an OH⁻ based resin may be regenerated by passing a NaOH solution over the anion resin. In another embodiment, the anion resin may be heated while passing a liquid or gas stream over the anion resin. In this approach, for example, the increase in temperature may act to release the trapped anion species from the anion resin, and the released anion species may be carried away by the liquid or gas stream. Typically, the released anion species include sulfur. In another embodiment, an anion-containing stream and heat may be used in conjunction to regenerate an anion resin.

Following regeneration, the anion resin may be re-used. Depending on the regeneration process used, the anion resin may be ready to be re-used immediately following regeneration, or the anion resin may need to be moved prior to re-use. For example, if the anion resin is regenerated in situ, the anion resin may be reused with little delay. In other examples, the anion resin may be removed from a treatment location, regenerated at a second location, and will therefore need to be returned to the treatment location before use.

The system and equipment used for contacting the organic stream with an anion resin may be designed to withstand the chemical environment and the various streams used and produced during treatment. For example, the system may be designed using stainless steel, which is resistant to various sulfur compounds, alcohol streams such as ethanol, and basic anion regeneration streams.

The processing may be conducted to produce commercial scale quantities of treated alcohol. For example, the amount of treated alcohol produced may be at a flow rate of 1 gallon/minute or more, 10 gallons per minute or more, 25 gallons per minute or more, 50 gallons per minute or more, 75 gallons per minute or more, 100 gallons per minute or more, or 150 gallons per minute or more. If hydrous alcohols are treated the flow rate may be higher than if anhydrous alcohols are treated. Similarly, the flow rate may be higher if alcohols with a higher water % are treated than alcohols with a lower water %. In addition, as described above, the flow rate may vary based on other factors including the sulfur and sulfate content, the bed size, the type of bed used, the loading of the resin, the type of resin, etc.

### Methods and Materials

### 1. Ethanol Specification

There may be standard requirements associated with an ethanol product produced for sale. These requirements are expressed as product specifications. According to the latest proposed industry specification for ethanol, motor fuel grade ethanol has specifications including corresponding test methods as follows:

| Quality Parameter | Specification | Test Method |
|---|---|---|
| Methanol, volume %, maximum | 0.5 | ASTM D5501 |
| Ethanol, volume %, minimum | 92.7 | ASTM D5501 |
| Water, weight %, maximum | 0.820 | ASTM D203 or ASTM D1064 |
| Acidity (as acetic acid), weight %, | 0.0070 | ASTM D1613 |
| maximum | | |
| Inorganic Chloride content, mass | 40 (32) | ASTM D512, modified |
| ppm (mg/L), maximum | | |
| Copper content, mg/kg (mg/L), | 0.10 (0.08) | ASTM D1688 |
| maximum | | |
| Solvent Washed Gum, mg/100 mL, | 5.0 | ASTM D381 |
| maximum | | |
| pH | 6.5–9.0 | ASTM D6423 |
| Specific Gravity | 0.78393–0.79718 | ASTM D4052 |
| API Gravity | Converted from Specific | Use Specific Gravity |
| | Gravity | Conversion Table |
| Sulfur, ppm, max | 10 | ASTM D5453 |
| Benzene, volume %, maximum | 0.06 | ASTM D5580 |
| Aromatic Hydrocarbons, volume | 1.7 | ASTM D5580 |
| %, maximum | | |
| Olefins, volume %, maximum | 0.5 | ASTM D6550 |
| Color (Saybolt), minimum | 25 | ASTM D156 |
| Appearance | Visibly free of suspended | Visual Inspection |
| | or precipitated | |
| | contaminants (clear and | |
| | bright) | |
| Total Sulfates** | ≦4 ppm | Lead titration; I.C. |

**Proposed addition to ethanol specification, currently pending

### 2. Test Methods

Samples in this application were tested for Total Sulfur (ppm) using an Antek® 9000 Sulfur Test Instrument (available from Antek Instruments, Houston, Tex.), under method ASTM D5453 “Standard Test Method for Determination of Total Sulfur in Light Hydrocarbons, Motor Fuels and Oils by Ultraviolet Fluorescence.” The analysis works by high temperature combustion of the samples, including the oxidation of sulfur to SO₂. The SO₂ is excited by exposure to UV light, and fluoresces as it returns to a steady state. The SO₂ fluorescence is detected and measured using a photomultiplier tube.

Total sulfates may be tested using a lead titration method, according to ASTM Method D6174 “Standard Test Method for Inorganic Sulfate in Surfactants by Potentiometric Lead Titration.” The method works by titration of inorganic sulfate using a standard lead solution. The titration endpoint is determined by an increase in lead activity using a lead selective electrode. The concentration is then calculated. However, the method may have poor repeatability for some samples due to potential interference issues.

Total sulfates may also be tested using an Ion Chromatography (“IC”) method, according to ASTM Method D5827 “Standard Test Method for Analysis of Engine Coolant for Chloride and Other Anions by Ion Chromatography.” In this procedure, a sample is injected into an ion chromatograph, and ions are separated based on their affinity for the resin. This separation of ions enables detection and measurement. Generally, the IC method is more sensitive and has higher repeatability and reproducibility than the titration method. Under some circumstances, a suppressor may be used to increase anion sensitivity of the test method when used with aqueous samples.

### EXAMPLES

In these examples, samples were generally taken periodically for testing. However, not all tests were conducted on every sample.

### Example 1

### Total Sulfur Reduction Testing

A series of initial screening tests were conducted to measure the reduction of sulfate ions present in an alcohol stream. A 10 gallon container was filled with ethanol for use in testing. A number of resins were obtained and tested for sulfur removal. The resins were used as purchased.

The testing of each resin was conducted by adding 30 mls of resin and 30 mls of ethanol from the 10 gallon container to a beaker. The combination was stirred for one minute at room temperature. After one minute, the treated ethanol was sampled and tested for total sulfur content using an Antek® 9000 Instrument (as described above).

A series of four runs was conducted, using fresh ethanol and fresh resin for each test. During each run series, a control sample of untreated ethanol was tested at the beginning of the run. During the first two run series, an additional control sample of untreated ethanol was tested at the end of the run. The results of the multiple series of test runs are reported in Table 1.

TABLE 1
Anion Resin Testing for Sulfur Reduction

| | Run #1 | Run #2 | Run #3 | Run #4 |
|---|---|---|---|---|
| | (ppm S) | (ppm S) | (ppm S) | (ppm S) |
| Control (untreated ethanol) | 2.25 | 2.1 | 3.2 | 3.4 |
| Treated Samples (post treatment): | | | | |
| Lewatit ® M + M-600 OH | 1.87 | 1.89 | 1.92 | 1.93 |
| Lewatit ® M + M-600 WS | 1.7 | 1.69 | 1.96 | 1.99 |
| Lewatit ® S6368 | 1.82 | 1.78 | 2.2 | 2.63 |
| Lewatit ® M + M-500 | 0.607 | 0.701 | 0.603 | 0.63 |
| Lewatit ® M + M-500-OH | 0.5 | 0.601 | 0.658 | 0.6632 |
| DOWEX ® MARA-OH | 1.25 | 1.32 | 1.8 | 1.96 |
| DOWEX ® IX-22-OH | 1.345 | 1.42 | 1.2 | 1.53 |
| Purolite ® A-100 | 1.028 | 0.985 | 1.03 | 1.23 |
| Purolite ® A-300 | 0.879 | 0.986 | 0.687 | 0.685 |
| Control (untreated ethanol) | 2.12 | 2.19 | | |

### Example 2

### Sulfate Ion and Sulfur Reduction Testing

A sample of ethanol was obtained and stored in a 30 gallon container for testing.

Purolite® A-300 resin was obtained and prepared for use by mixing 100 mls of resin with 3% NaOH for 24 hours. The resin was removed from the liquid and strained.

A 30 ml resin cylinder was packed with 30 mls of the dried resin. The resin column was connected to a pump. The pump was set to provide a flow rate of 31.5 mls ethanol/minute to the column. The test continued for 24 hours, resulting in a total flow of 45,360 mls. Samples of untreated and treated ethanol were tested periodically, with the results shown in Table 2.

The untreated ethanol (feedstock) was tested for total sulfur levels every 8 hours using an Antek® 9000. In addition, at the start of the test, and 8 hours into the test, duplicate samples were tested for sulfate content using a lead titration method.

The treated ethanol was tested every two hours for total sulfur using an Antek® 9000. Duplicate samples of treated ethanol were also tested for sulfate content at the start of the test, and after 14 hours, and after 24 hours. Each duplicate sample was sent to an external lab for testing.

TABLE 2
24 hour Anion Resin Treatment Testing (31.5 ml/min)

| | Untreated Ethanol Samples | | Treated Ethanol Samples | |
|---|---|---|---|---|
| | | Total Sulfur, | | Total Sulfur, |
| | Sulfate ions, | ppm (duplicate | Sulfate ions, | ppm (duplicate |
| Time (hrs) | ppm | sample) | ppm | sample) |
| 0 | 3.4 | 7.26 (9.21) | 0.56 | 1.19 (0.47) |
| 2 | | | 0.68 | |
| 4 | | | 0.62 | |
| 6 | | | 1.04 | |
| 8 | 4.38 | 7.06 (784) | 0.89 | |
| 10 | | | 0.93 | |
| 12 | | | 1.02 | |
| 14 | | | 1.02 | 0 (0) |
| 16 | 3.76 | | 1.1 | |
| 18 | | | 1.2 | |
| 20 | | | 0.88 | |
| 22 | | | 1.14 | |
| 24 | 5.1 | | 0.8 | 0 |

| | |
|---|---|
| Flow | 31.5 ml/min |
| Total Volume | 45,360 mls |

### Example 3

### Total Sulfur Reduction Testing

Another test was run according to the steps described in Example 2. However, the flow rate for this trial was set to 55 mls ethanol/minute rather than 31.5. In addition, only total sulfur testing using an Antek® 9000 was conducted. The samples and results are shown below in Table 3.

TABLE 3
24 hour Anion Resin Treatment Testing (55 ml/min)

| | Untreated Ethanol | Treated Ethanol |
|---|---|---|
| Time | Samples - Total | Samples - Total |
| (hrs) | Sulfur, ppm | Sulfur, ppm |
| 0 | 3.2 | 0.508 |
| 2 | | 0.625 |
| 4 | | 0.355 |
| 6 | | 0.637 |
| 8 | | 0.454 |
| 10 | | 0.53 |
| 12 | 3.4 | 0.61 |
| 14 | | 0.55 |
| 16 | | 0.55 |
| 18 | | 0.635 |
| 20 | 3.9 | 0.456 |
| 22 | | 0.52 |
| 24 | | 0.58 |

| | |
|---|---|
| Flow | 55 ml/min |
| Total Volume | 79,200 mls |

### Example 4

### Copper Comparative Testing

Another test was run according to the steps described in Example 2. However, the cylinder was filled with 30 mls of copper turnings (AR-189, available from Alpha Resources). The initial flow rate was 31 mls ethanol/min, but as the test progressed, the flow rate reduced due to swelling of the copper tunings as they removed sulfate from the ethanol stream. This swelling cause a reduction in flow rate, until eventually, at 15 hours, the flow rate was almost fully constricted.

The use of copper also impacted sample testing. Copper leeching into the treated ethanol interfered with testing for sulfates (though not for total sulfur). The internal testing returned unusable results, while the external testing of duplicate samples showed very high variation in test results. Therefore, the reported sulfate results are highly suspect. However, the total sulfur results show ongoing significant sulfur reduction. All testing results are reported on Table 4.

TABLE 4
Copper Comparison - Sulfur Reduction

| | | Untreated - | Treated - | |
|---|---|---|---|---|
| Time | Flow rate | Total Sulfur, | Total Sulfur, | Treated - Sulfate, |
| (hrs) | (mls/min) | ppm | ppm | ppm (external) |
| 1 | 31 | 3.4 | 1.09 | 0, 1.13 |
| 2 | | 4.38 | 1.28 | |
| 3 | | 2.89 | 0.898 | |
| 4 | | 3.59 | 0.64 | |
| 5 | | 3.76 | 1.14 | |
| 6 | 15 | 3.89 | 1.4 | |
| 7 | | 3.57 | 1.35 | |
| 8 | | 3.2 | 1.26 | |
| 9 | | 5.1 | 1.29 | |
| 10 | | 4.45 | 0.9 | |
| 11 | | 48 | 1.58 | |
| 12 | | 4.85 | 1.56 | |
| 13 | | 4.62 | 1.4 | |
| 14 | 1 | 4.89 | 1.5 | 0, 3 |
| 15 | 0 | | | |

### Example 5

Another test was run according to the steps described in Example 2. One purpose of the test was to locate the loading or breakthrough point of the resin. The flow rate of ethanol was set to 50 mls/min, and samples were taken and tested periodically, as shown in Table 5. More ethanol was added to the container during the testing run to ensure that there was sufficient material present to complete testing. The ethanol added was obtained from the same sampling point as the initial ethanol sample.

As can be seen, the inflection point for the resin occurred after 26 hours of treatment (78,000 mls). After 40 hours, the resin was removing very little sulfur (including sulfates).

TABLE 5
Anion Resin Treatment - Loading Test

| | Untreated | Treated |
|---|---|---|
| | Feed - Total | Ethanol - Total |
| Time (hrs) | Sulfur, ppm | Sulfur, ppm |
| 0 | 2.3 | 0.4 |
| 3 | | 0.632 |
| 6 | | 0.826 |
| 9 | | 0.623 |
| 12 | | 0.563 |
| 15 | 2.1 | 0.508 |
| 18 | | 0.3 |
| 21 | | 0.33 |
| 24 | | 0.596 |
| 25 | 4.3 | 0.482 |
| 26 | | 0.552 |
| 27 | | 0.57 |
| 28 | | 0.813 |
| 30 | | 1.1 |
| 33 | | 1.7 |
| 36 | | 2 |
| 38 | | 2.3 |
| 40 | 4.1 | 4 |

| | |
|---|---|
| Flow Rate | 50 mls/min |
| Total Run Time | 40 hrs |
| Total Vol (mls) | 120,000 mls |

### Example 6

A sample of ethanol was obtained and stored in a 30 gallon container for testing. Periodically, additional ethanol was obtained from the same sampling location and added to the container as needed to complete the testing run.

Three pumps and resin columns were attached to the container to pull a feed ethanol from the container. The material initially in the container and samples of the material later added to the container were tested for total sulfates. The sample results are reported in Table 6, with duplicate testing separated by commas.

TABLE 6
Ethanol Feed Testing - Sulfate Levels

| | Ethanol Feed - |
|---|---|
| | Total Sulfates, |
| Time (hrs) | ppm |
| 0 | 4.65 |
| 12 | 5.96 |
| 20 | 5.96 |
| 24 | 5.98 |
| 28 | 6.09, 6.57 |
| 43 | 9.29, 9.57 |
| 45 | 1.39 |
| 48 | 1.37 |
| 52 | 0.85 |
| 56 | 0.63 |
| 60 | 2.04 |
| 64 | 2.36, 2.24 |

### Example 6A

One column was prepared using Lewatit® M&M 500 OH Resin (available from Bayer) that was obtained and used as purchased. A 30 ml resin cylinder was packed with 30 mls of the resin. The resin column was connected to a pump. The pump was set to provide a flow rate of 40 mls ethanol/minute to the column. The test continued for 68 hours, resulting in a total flow of 163,200 mls. The sample at 68 hours shows the start of the break-through point of the bed, as the resin begins to reach full loading.

Samples of treated ethanol were tested periodically, as shown on Table 6A. Total sulfur levels were tested using an Antek® 9000. Sulfate Levels were tested using the IC method.

TABLE 6A
Anion Resin Treatment - M + M 500 OH Resin Test

| | Treated Ethanol - | Treated Ethanol - |
|---|---|---|
| | Total Sulfur, | Total Sulfates, |
| Time (hrs) | ppm | ppm |
| 0 | | 0.29 |
| 4 | | 0.43 |
| 12 | | 0.34 |
| 16 | | 0.29 |
| 20 | | 0.37 |
| 22 | 2.13 | 0.36 |
| 24 | 2.93 | 0.38 |
| 26 | 2.10 | 0.74 |
| 28 | 2.82 | 0.48 |
| 30 | 3.38 | 0.45 |
| 43 | 2.71 | 0.45 |
| 44 | 3.10 | 0.44 |
| 45 | 2.49 | 0.58 |
| 46 | 2.20 | 0.39 |
| 48 | 3.00 | 0.55 |
| 50 | 1.48 | 0.38 |
| 52 | 1.96 | 0.46 |
| 54 | 3.42 | 0.43 |
| 56 | 1.96 | 0.42 |
| 58 | 2.27 | 0.55 |
| 60 | 2.44 | 0.52 |
| 62 | 3.06 | 0.53 |
| 64 | 2.35 | 0.93 |
| 66 | | 0.88 |
| 68 | 4.50 | 0.97 |

| | |
|---|---|
| Flow Rate | 40 mls/min |
| Total Run Time | 65 hrs |
| Total Vol (mls) | 163,200 |

### Example 6B

Another column was prepared using DOWEX® IX-22 OH Resin (available from Dow Chemical) that was obtained and used as purchased. A 30 ml resin cylinder was packed with 30 mls of the resin. The resin column was connected to a pump. The pump was set to provide a flow rate of 40 mls ethanol/minute to the column. The test continued for 66 hours, resulting in a total flow of 158,400 mls.

Samples of treated ethanol were tested periodically, as shown on Table 6B. Total sulfur levels were tested using an Antek® 9000. Sulfate Levels were tested using the IC method.

TABLE 6B
Anion Resin Treatment - IX-22 OH Resin Test

| | Treated Ethanol - | Treated Ethanol - |
|---|---|---|
| | Total Sulfur, | Total Sulfates, |
| Time (hrs) | ppm | ppm |
| 0 | | 0.11 |
| 4 | | 0.14 |
| 12 | | 0.12 |
| 16 | | 0.13 |
| 20 | | 0.53 |
| 22 | 1.85 | 0.80 |
| 24 | 2.00 | 1.14 |
| 26 | 1.74 | 0.85 |
| 28 | 2.09 | 0.86 |
| 30 | 2.54 | 0.43 |
| 43 | 1.82 | 0.67 |
| 44 | 1.49 | 1.01 |
| 45 | 2.20 | 1.08 |
| 46 | 1.97 | 1.10 |
| 48 | 1.80 | 1.10 |
| 50 | 2.15 | 1.14 |
| 52 | 2.03 | 1.19 |
| 54 | 3.37 | 1.24 |
| 56 | 3.77 | 1.22 |
| 58 | 3.07 | 1.21 |
| 60 | 2.41 | 1.35 |
| 62 | 3.32 | 1.64 |
| 64 | 2.99 | 1.61 |
| 66 | 3.10 | 1.80 |

| | |
|---|---|
| Flow Rate | 40 mls/min |
| Total Run Time | 66 hrs |
| Total Vol (mls) | 58,400 |

### Example 6C

Another column was prepared using Purolite® A-300 resin (available from Purolite) that was obtained and used as purchased. A 30 ml resin cylinder was packed with 30 mls of the prepared resin. The resin column was connected to a pump. The pump was set to provide a flow rate of 40 mls ethanol/minute to the column. The test continued for 66 hours, resulting in a total flow of 158,400 mls. Samples of treated ethanol were tested periodically, as shown on Table 6C. Total sulfur levels were tested using an Antek® 9000. Sulfate Levels were tested using the IC method.

TABLE 6C
Anion Resin Treatment - A-300 OH Resin Test

| | Treated | Treated |
|---|---|---|
| | Ethanol - Total | Ethanol - Total |
| Time (hrs) | Sulfur, ppm | Sulfates, ppm |
| 0 | | |
| 4 | | 0.05 |
| 12 | | 0.11 |
| 16 | | 0.00 |
| 20 | | 0.19 |
| 22 | | 0.10 |
| 24 | 0.67 | 0.15 |
| 26 | 1.26 | 0.12 |
| 28 | 0.42 | 0.15 |
| 30 | 0.71 | 0.35 |
| 43 | 0.98 | 0.34 |
| 44 | 2.55 | 0.33 |
| 45 | 2.00 | 0.35 |
| 46 | 1.50 | 0.32 |
| 48 | 1.99 | 0.42 |
| 50 | 2.30 | 0.40 |
| 52 | 1.88 | 0.39 |
| 54 | 1.79 | 0.43 |
| 56 | 3.42 | 0.45 |
| 58 | 2.19 | 0.23 |
| 60 | 2.58 | 0.37 |
| 62 | 2.48 | 0.45 |
| 64 | 2.97 | 0.47 |
| 66 | 2.55 | 0.54 |

| | |
|---|---|
| Flow Rate | 40 mls/min |
| Total Run Time | 66 hrs |
| Total Vol (mls) | 158,400 |

A number of embodiments of the invention have been described. Nevertheless, it will be understood that various modifications may be made without departing from the spirit and scope of the invention. Accordingly, other embodiments are within the scope of the following claims.

1-22. (canceled)

23. A method of producing a motor fuel component, comprising:
contacting an ethanol with an anion resin to reduce the concentration of sulfate ions in the ethanol and form a treated ethanol; and
adding a denaturant to the treated ethanol.

24. The method of claim 23, wherein the denaturant comprises natural gasoline, unleaded gasoline, reformate, or naphtha components.

25. The method of claim 23, wherein the denaturant comprises denatonium benzoate.

26. The method of claim 23, wherein the treated ethanol has a sulfate ion concentration of 4 ppm or less.

27. The method of claim 23, wherein the treated ethanol has a sulfate ion concentration of 2 ppm or less.

28. The method of claim 23, wherein the treated ethanol has a sulfate ion concentration of 1 ppm or less.

29. The method of claim 23, wherein the treated ethanol has a total sulfur concentration of 10 ppm or less.

30. The method of claim 23, wherein the ethanol has a sulfate ion concentration of 4 ppm or greater.

31. The method of claim 23, wherein the anion resin comprises a hydroxide based resin.

32. The method of claim 23, wherein the ethanol further comprises additional sulfur-containing ions and contacting the ethanol with an anion resin reduces the concentration of additional sulfur-containing ions.

33. The method of claim 23, wherein the treated ethanol is produced at a rate of 1 gallon per minute or more.

34. The method of claim 23, wherein the treated ethanol is produced at a rate of 50 gallons per minute or more.

35. The method of claim 23, wherein the ethanol is derived from biomass.
